(19) United States
(12) Patent Application Publication
(10) Pub. No.: US 2002/0157001 A1
(43) Pub. Date: Oct. 24, 2002

(54) Computer system capable of switching operating system

(76) Inventors: Alec Huang, Taipei (TW); Mark Chen, Yunghe City (TW)

Correspondence Address: RABIN & CHAMPAGNE, P.C., Suite 500, 1101 14 Street, N.W., Washington, DC, 20005, US

(21) Appl. No.: 10/095,462

(22) Filed: Mar. 13, 2002

(30) Foreign Application Priority Data
Apr. 19, 2001 (TW) 90109082

(51) Int. Cl. G06F 15/177; G06F 9/00; G06F 9/24

(52) U.S. Cl. 713/2; 713/1

(57) ABSTRACT

A computer system, having a portable computer and an expanding apparatus. The portable computer has a display, a first storage apparatus to store a first operating system and an operating system load program, a processing circuit to execute the first operating system for controlling operation of the computer system, and a connector. The expanding apparatus has a second storage apparatus to store a second operating system. When the connector of the portable computer is disconnected with the expanding apparatus, the processing circuit executes the first operating system to allow the portable computer operating independently. When the connector is coupled to the expanding apparatus, the processing circuit uses the operating system load program to load and execute the second operating system, while the first operating system is terminated. In addition, a docking station may also be installed in the expanding apparatus to dispose the portable computer thereon.

### FIELD OF THE INVENTION

The present invention relates in general to a computer system. More particularly, the present invention relates to a computer system capable of switching operating system.

### DESCRIPTION OF THE RELATED ART

Referring to FIG. 1, a schematic drawing of a conventional computer system 10 is shown. The computer 10 is a personal data assistant (PDA). Generally speaking, the personal data assistant is a portable and broadly applied computer system that provides the user the functions of schedule management, data input and storage. The portable characteristic allows the user to record data and provides great convenience for users such as sales and production line managers to dynamically process computer data. However, as the personal data assistant 10 itself cannot provide a larger data storage capacity to store more program; therefore, when the personal data assistant 10 is booted, the application program is very limited at the same time. In addition, the hardware of the personal data assistant 10 has to be specially designed, so that only the specific operating system can be executed. Generally, the personal data assistant 10 cannot be operated under other operating system. For example, the Palm series that has the most market share, including Palm III, IV or V produced by 3COM Corporation, only has a storage capacity of 8M bytes. With such limited data storage capacity, very limited program can be stored. Therefore, it is impossible for the user to run too many programs at the same time. In addition, the Palm series personal data assistant has to be operated under a specially designed operating system. Other operating system such as Microsoft Windows NT is not applicable, so that the related program such as Microsoft Office cannot be executed at all. The function provided by such personal data assistant is thus seriously restricted.

Referring to FIG. 2, a schematic drawing of another conventional computer system 20 is shown. The computer system 20 is a personal computer that includes a host machine 22 and a display 24. Generally speaking, a lot of the data storage apparatus for storing programs such as hard disc and digital versatile disc are applicable to the personal computer 20. Compared to the personal data assistant 10, the personal computer 20 has much more storage space to store a lot more programs and provides more functions to the users. However, the far larger volume and heavier weight compared to the personal data assistant 10 results in poor portability. Even for the very popular laptop computer, the portability and power consumption are much inferior. To a user who is very critical to portability, the practicability is never satisfactory.

Referring to FIG. 3, the connection between the personal data assistant 10 as shown in FIG. 1 and the computer system 20 as shown in FIG. 2 is schematically illustrated. When the job nature of the user requires both the convenience of the personal data assistant 10 and the powerful function of the personal computer 20, both the personal data assistant 10 and the personal computer 20 are purchased and applied according to the specific working condition. For example, when the user requires dynamically processing computer data, the data can be input to the personal data assistant 10 first. When a huge program is required to execute for completion of a task, the personal computer 20 is used. This undoubtedly increases the expense of the user. In addition, as the personal computer 20 can only be applied as a data source for the personal data assistant 10, the magnificent resource and calculation power cannot be applied thereto. The systems resources of the personal data assistant 10 and the personal computer 20 cannot be integrated efficiently. This causes the inconvenience for the user. In addition, as the personal data assistant 10 and the personal computer 20 have their respective displays 12 and 24, the redundant disposition of displays occurs.

### SUMMARY OF THE INVENTION

The present invention provides a computer system including a portable computer and an expanding apparatus. The computer system includes a personal data assistant which can be operated under a first operating system. The user can thus conveniently carry the personal data assistant about. A second operating system such as Window 98 is stored in the expanding apparatus. Therefore, by connecting the portable computer system to the expanding apparatus, the portable computer can be operated under the second operating system. Therefore, the user can run the application program, for example, Microsoft Office, operating under the second operating system. Thus, the computer system provided by the present invention has the function of switching operating system to satisfy the convenience and versatile functions requirements for the users. Further, the redundant disposition of displays is avoided.

Both the foregoing general description and the following detailed description are exemplary and explanatory only and are not restrictive of the invention, as claimed.

### BRIEF DESCRIPTION OF THE DRAWINGS

FIG. 1 shows a schematic drawing of a conventional computer system;

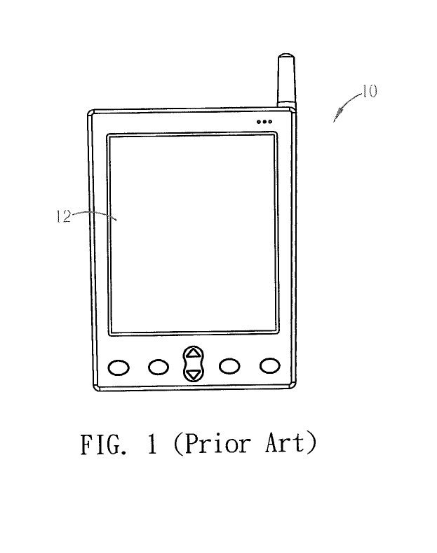

FIG. 2 shows a schematic drawing of another conventional computer system;

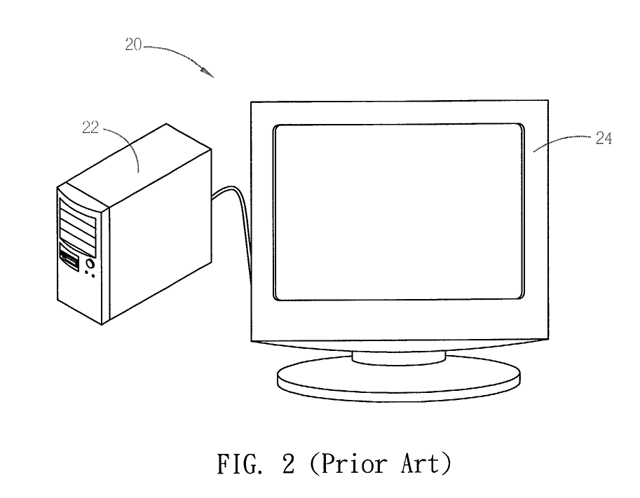

FIG. 3 shows the connection between the personal data processing circuit as shown in FIG. 1 and the computer system as shown in FIG. 2;

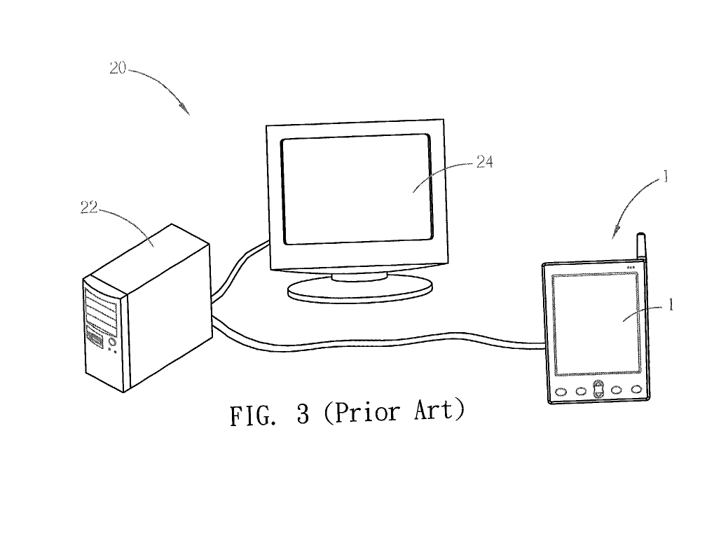

FIG. 4 shows a computer system and expanding apparatus of a computer system provided by the present invention, where the computer system is disconnected with the expanding system;

FIG. 5 shows the connection between the computer system and the expanding apparatus as shown in FIG. 4;

FIG. 6 shows a function block diagram of the computer system as shown in FIG. 4;

FIG. 7 shows the initial connection state between the computer system and the expanding apparatus as shown in FIG. 4; and

FIG. 8 shows a schematic drawing of connecting the computer system to a network.

### DESCRIPTION OF THE PREFERRED EMBODIMENTS

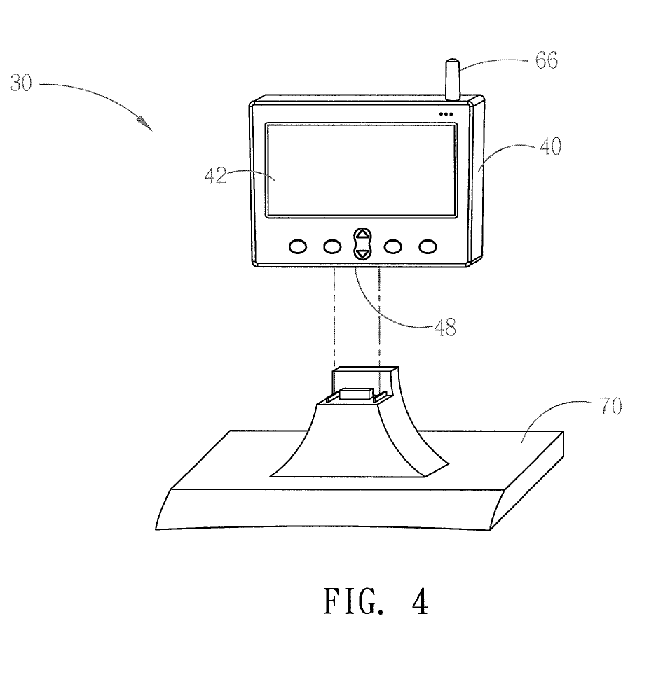

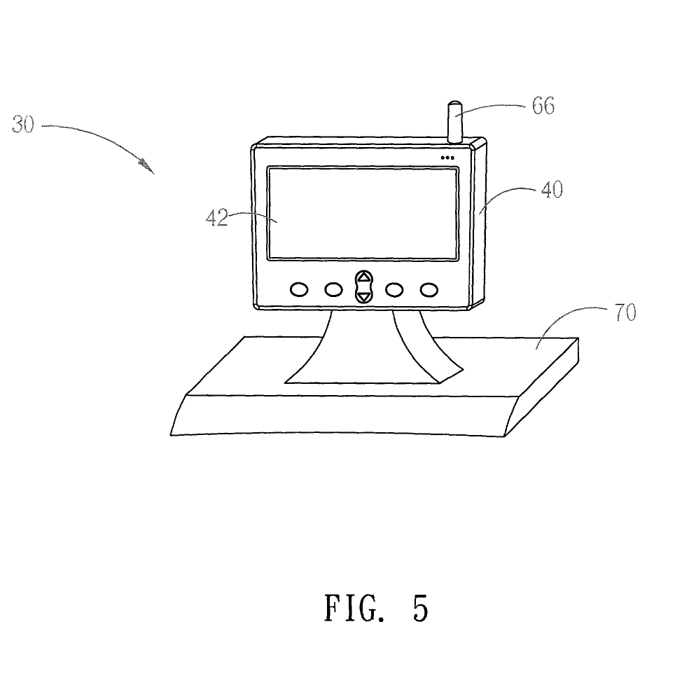

Referring to FIGS. 4 and 5, a computer system 30, and disconnected portable computer 40 and expanding apparatus 70 of the computer system 30 are shown in FIG. 4, while the connection between the portable computer 40 and the expanding apparatus 70 is schematically shown in FIG. 5. The computer system includes the portable computer 40 and the expanding apparatus 70. The portable computer 40 includes a personal data assistant (PDA), while the expanding apparatus 70 includes a docking station able to dispose the portable computer 40 thereon stably.

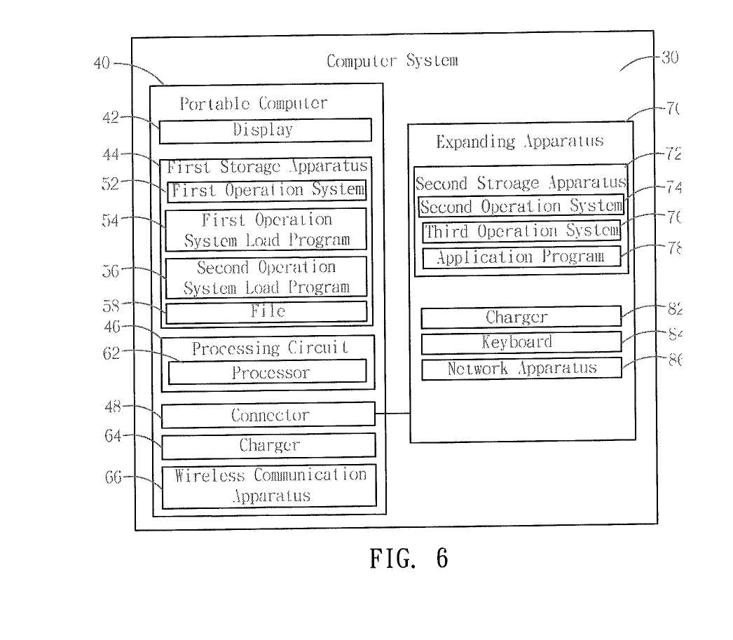

In FIG. 6, a function block diagram of the computer system 30 as shown in FIG. 4 is illustrated. The portable computer 40 comprises a display 42 to display operation information to a user, a first storage apparatus 44 to store a first operating system 52, a first operating system load program 54, a second operating system load program 56, a processing circuit 46 to execute the first operating system load program 52, and a connector 48, to connect the expanding apparatus 70 thereto. When the portable computer 40 is booted, the processing circuit 46 executes the first operating load program 54 to perform the related system inspection and initialization. The expanding apparatus 70 comprises a second storage apparatus 72 to store a second operating system 74 and at least one application program 78. When the portable computer 40 is disconnected with the expanding apparatus 70 as shown in FIG. 4, the processing circuit 46 executes the first operating system 52 to allow the portable computer 40 operating independently. Thus, the user can carry the portable computer 40 and uses whenever it is required. For example, a factory inventory manager can use the portable computer 40 to input the inventory data for stock taking, while another stock control manager can use the portable computer 40 to input the in-stock and out-of-stock data. In addition, when the portable computer 40 is connected to the expanding apparatus 70 (as shown in FIG. 5), the processing circuit 46 can selectively execute the second operating system load program 56 to load and execute the second operating system 74 and terminates the execution of the first operating system 52. Therefore, the user can use the application program 78 under the second operating system 74. For example, after the inventory manager or the stock control manager inputs the data, by connecting the portable computer 40 to the expanding apparatus 70 to execute the application program 78 under the second operating system 74, the previously input data can be further processed.

In this embodiment, the first storage apparatus 44 includes a flash memory, which stores a first operating system 52 constructed according to a Unix core program, and the processing circuit 46 includes a processor 62. When the portable computer 40 is disconnected with the expanding apparatus 70, the processing circuit 46 executes the first operating system 52 for performing related calculation of the portable computer 40 via the processor 62. When the portable computer 40 is connected to the expanding apparatus 70 through the connector 48, the processing circuit 46 selectively executes the second operating system load program 56 to load the second operating system 74, so that the operating system executed by the processing circuit 46 is switched from the first operating system 52 to the second operating system 74. In addition, the second operating system 74 further provides a system file reading function to allow the user reading the file 58 stored in the first storage apparatus 44 under the first operating system 52 while the processing circuit 46 is executing the second operating system 74. Thus, the file 58 can be read and processed under various operating systems. Further, in the current embodiment, the system file reading function is built in the second operating system 74. When the user intends to read the file 58 stored in the first storage apparatus 44 while the processing circuit 46 is executing the second operating system 74, an application program 78 can be used to achieve such intention in addition to the second operating system 74. For example, a program designed by a software provider can be stored in the second storage apparatus 72, and the user can execute such program to read the file 58 stored in the first storage apparatus 44 under the second operating system 74.

Particularly, when the portable computer 40 is connected to the expanding apparatus 70, the portable computer 40 can switch the operating system executed by the processing circuit 46 from the first operating system 52 to the second operating system 74 by loading the executing the second operating system load program 56 instead of being rebooted. After the processing circuit 46 successfully executing the second operating system 74, the execution of the first operating system 52 is terminated. When the processing circuit 46 is executing the second operating system 74, if the connection between the portable computer 40 and the expanding apparatus 70 is cut off, the processing circuit 46 will again load the second operating system load program 56 to execute the first operating system 52 and stop executing the second operating system 74 without rebooting the portable computer 40. In addition to the portable computer 40 that switches operating system without being rebooted, the computer 30 can also be designed to switch operating system by rebooting. When the portable computer 40 has to be rebooted for switching operating system, the processing circuit 46 executes the first operating system load program 54 stored in the booting sector of the first storage apparatus 44, which then executes stack initialization and system inspection to load the second operating system load program 56. Being executed, the second operating system load program 56 waits for the input of the user to determine whether the first operating system 52 is to be loaded into the flash memory 44, or the second operating system 74 stored in the second storage apparatus is loaded. Thus, the user can select the operating system to be executed.

In the embodiment, the second storage apparatus 72 includes a hard disc, the second operating system 74 includes the Windows NT operating system provided by Microsoft Corporation, and the application program 78 stored in the hard disc 72 includes the program designed for the Windows NT platform, for example, the Internet Explorer (IE), Excel, Word of Microsoft Corporation. When the processing circuit 46 is executing the second operating system (Windows NT) 74, various application programs 78 such as IE, Excel, Word can be executed via the second operating system 74 by the processing circuit 46 of the portable computer 40. Thus, by executing the application program 78 stored in the second storage apparatus 72 via the processing circuit 46, the computer system 30 provides more functions to the user.

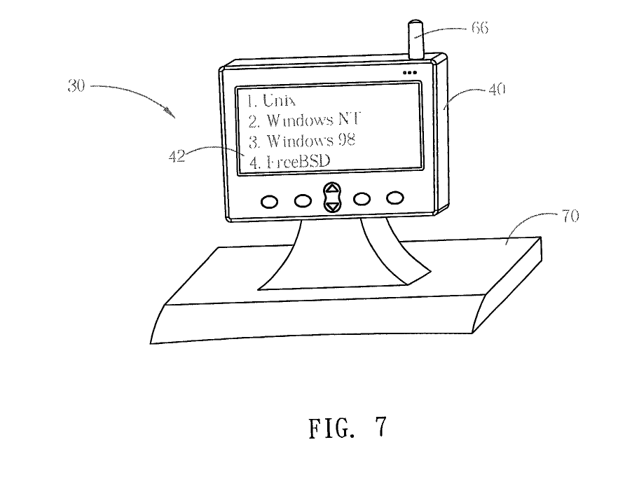

Referring to FIG. 7, an initial connecting status between the portable computer 40 and the expanding apparatus 70 is schematically illustrated. When the portable computer 40 is connected to the expanding apparatus 70 via the connector 48, the processing circuit 46 displays a selection frame on the display 40 for the user to decide which operating system is to be executed. Being decided by the user, the processing circuit 46 loads the second operating system load program 56 to execute the corresponding operating system according to the decision of the user. For example, when the user selects the Windows NT in the second option, the processing circuit 46 loads and executes the Windows NT operating system (the second operating system 74) and stops the first operating system (Unix) 52. When the user selects the first option Unix, the processing circuit 46 continues executing the first operating system 52. The second storage apparatus 72 can store multiple operating systems, for example, at least a third operating systems 76. When the portable computer 40 is connected to the expanding apparatus 70 via the connector 48, the processing circuit 40, again displays a selection frame for the user to select. Meanwhile, an additional option, for example, Window 98 or FreeBSD, corresponding to the third operating system 76 is popped up on the screen. The previously introduced operation flows of the computer system 30 are only preferred embodiments of the present invention. The user can decide whichever operating system as required. In addition, the processing circuit 46 can also be designed to automatically detect the existence or connection of the expanding apparatus 70 through the connector 48, and automatically execute the second operating system load program 56 to load and execute the second operating system 74.

Further, for the operation convenience of the user, the display 42 includes a touch panel to allow the user operating the portable computer 40 by touching the display 42. When the user touches the display 42, according to the touching position and method, a corresponding signal is generated by the display 42 and transmitted to the processing circuit, which then executes the corresponding calculation and operation according to this generated signal.

In addition, as shown in FIG. 6, the portable computer 40 further comprises a wireless communication apparatus 66 and a charger 64, while the expanding apparatus 70 further comprises a charger 82 and a network apparatus 86. The wireless communication apparatus 66 meets the code division multiple access (CDMA) system specification to record the identification data of the user into a chip (not shown). The portable computer 40 transmits and receives the data via the wireless communication apparatus 66. When the portable computer 40 is disconnected with the expanding apparatus 70, the charger 64 supplies power to the portable computer 40. When the portable computer 40 is connected to the expanding apparatus 70, the charger 82 supplies power to the portable computer 40 and charges the charger 64.

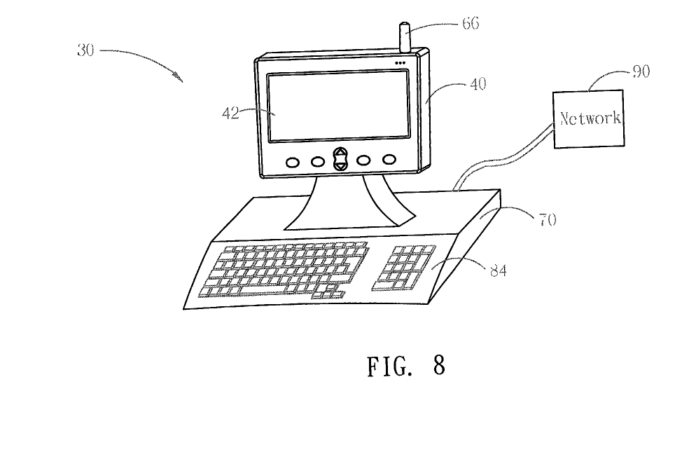

Referring to FIG. 8, the connection from between the computer system 30 as shown in FIG. 4 and a network 90 is schematically illustrated. The expanding apparatus 70 includes a keyboard 84. When the portable computer 40 is connected to the expanding apparatus 70, the user can operate the computer system 30 via the keyboard 84. In addition, the portable computer 40 can be connected to a network 90 via a network apparatus 86, such that data can be transmitted via the network 90.

As mentioned above, the first storage apparatus 44 of the embodiment includes a flash memory and the second storage apparatus 72 includes a hard disc. It is appreciated that the above storage apparatus are not limited to flash memory or hard disc only. In fact, the manufacturer of the computer system 30 can select different data storage apparatus, for example, read only memory and a CD ROM applied to the first and second storage apparatus 44 and 72, respectively.

Compared to the conventional computer system, the present invention includes a portable computer and an expanding apparatus. The portable computer can be connected to the expanding apparatus via a connector, and thereby, to allow the processing circuit executing the first operating system to perform an operation independent of the expanding apparatus. Alternatively, the portable computer can be connected to the expanding apparatus, so that the processing circuit can use an operating system load program to load and execute a second operating system load program stored in the second storage apparatus of the expanding apparatus, so as to execute the application program stored therein.

Other embodiments of the invention will appear to those skilled in the art from consideration of the specification and practice of the invention disclosed herein. It is intended that the specification and examples to be considered as exemplary only, with a true scope and spirit of the invention being indicated by the following claims.

What is claimed is:

1. A computer system, comprising:
a portable computer, further comprising:
a display;
a first storage apparatus, to store a first operating system and an operating system load program;
a processing circuit, to execute the first operating system to control operation of the computer system; and
a connector; and
an expanding apparatus, further comprising:
a second storage apparatus, to store a second operating system;
wherein when the connector of the portable computer is disconnected with the expanding apparatus, the processing circuit of the portable computer executes the first operating system to allow the portable computer operating independently, and when the connector of the portable computer is connected to the expanding apparatus, the processing circuit uses the operating system load program to load and execute the second operating system stored in the second storage apparatus of the expanding apparatus to replace the first operating system.

2. The computer system according to claim 1, wherein the portable computer includes a personal data assistant (PDA).

3. The computer system according to claim 1, wherein expanding apparatus includes a docking station to allow the portable computer disposed thereon.

4. The computer system according to claim 1, wherein the portable computer is connected to the expanding apparatus, a user can drive the operating system load program to load and execute the second operating system stored in the second storage apparatus of the expanding apparatus.

5. The computer system according to claim 1, wherein when the portable computer is connected to the expanding apparatus, the processing circuit detects the expanding apparatus via the connector and automatically executes the operating system load program to load and execute the second operating system and stop the first operating system.

6. The computer system according to claim 1, wherein when a connection between the portable computer and the expanding apparatus is cut off, the processing circuit executes the operating system load program to execute the first operating system, and terminate the second operating system.

7. The computer system according to claim 1, wherein the second storage apparatus further comprises an application program, and when the processing circuit is executing the second operating system, the portable computer executes the application program via the second operating system and displays an operation of the application program on the display.

8. The computer system according to claim 1, wherein the second storage apparatus further comprises a third operating system, and when the portable computer is connected to the expanding apparatus, the processing circuit displays a selection frame on the display to allow a user to decide which operating system to be executed, and the processing circuit executes a selected operating system load program decided by the user to load and execute the corresponding operating system.

9. The computer system according to claim 1, wherein the second operating system comprises a system file reading function to read a file stored in the first storage apparatus under the first operating system.

10. The computer system according to claim 1, wherein the portable computer further comprises a charger, and the expanding apparatus further comprises another charger, and when the portable computer is disconnected with the expanding apparatus, the charger of the portable computer supply power thereto, while when the portable computer is connected to the expanding apparatus, the charger of the expanding apparatus supplies power to the portable computer and charges the charger of the portable computer.

11. The computer system according to claim 1, wherein the processing circuit comprises a processor to process operation of the computer system.

12. The computer system according to claim 1, wherein the portable computer further comprises a wireless communication apparatus, by which the portable computer transmits and receives data.

13. The computer system according to claim 12, wherein the wireless communication apparatus meets the code division multiple access (CDMA) system specification.

14. The computer system according to claim 1, wherein the expanding apparatus further comprises a keyboard, by which a user controls the computer system when the portable computer is connected to the expanding apparatus.

15. The computer system according to claim 1, wherein the display comprises a touch panel, and a user controls the computer system by touching the touch panel.

16. The computer system according to claim 1, wherein the expanding apparatus further comprises a network apparatus, via which data is transmitted between the portable computer and a network when the portable computer is connected to the expanding apparatus.

17. The computer system according to claim 1, wherein the first storage apparatus comprises a read only memory.

18. The computer system according to claim 1, wherein the first storage apparatus comprises a flash memory.

19. The computer system according to claim 1, wherein the second storage apparatus comprises a hard disc.

20. The computer system according to claim 1, wherein the second storage apparatus comprises a CD ROM.
